(19) United States
(12) Patent Application Publication
(10) Pub. No.: US 2004/0212938 A1
(43) Pub. Date: Oct. 28, 2004

(54) CURRENT PATH BETWEEN PRINTED CIRCUIT BOARDS FOR ELECTROSTATIC DISCHARGE PROTECTION

(76) Inventors: Tung-Wei KAO, Taipei City (TW); Hung-I LAI, Taipei City (TW); Chia-Hung YEN, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,166

(22) Filed: Apr. 19, 2004

(30) Foreign Application Priority Data
Apr. 22, 2003 (TW) 092206500

(51) Int. Cl. H02H 9/00

(52) U.S. Cl. 361/56

(57) ABSTRACT

An electrostatic discharge protection circuit includes a first printed circuit board including a first grounding line, a flexible cable including a connecting line having one end connected to the first grounding line, an electrostatic discharge protection path having one end connected to the first grounding line, a second printed circuit board including a second grounding line electrically connected to another end of the connecting line, and a housing connected to another end of the electrostatic discharge protection path.

### BACKGROUND OF INVENTION

1. Field of the Invention

The present invention relates to an electrostatic discharge (ESD) protection circuit, and more particularly, to an electrostatic discharge protection circuit for preventing electrostatic discharge current between two separated printed circuit boards.

2. Description of the Prior Art

In general, the human body accumulates electrostatic charge, which can amount to several thousands of volts. If a human body contacts metal or conductive material, such as an IC chip or a circuit board having embedded IC chips, the electrostatic charge on the human body can discharge to the IC chip or the circuit board. This is known as electrostatic discharge (ESD). The electrostatic discharge current can cause damage to the IC chips.

Please refer to FIG. 1. FIG. 1 is a schematic diagram of circuit boards of a conventional slim optical disk drive. The slim optical disk drive includes a sub-board 200 fixed on a tray, and a main board 100 fixed on a housing. A flexible cable 300, such as a U-shaped flexible cable, can transmit control signals between the main board 100 and the sub-board 200. In general, the part of the flexible cable 300 between a dotted line 310 and the main board 100 adheres to a housing of the slim optical disk drive, while the part between the dotted line 310 and the sub-board 200 is flexible. Therefore, although the sub-board 200 slides in and out with the tray, the sub-board 200 can still communicate with the main board 100 via the flexible cable 300.

In general, the sub-board 200 includes a spindle motor 202, a motor driving IC 204, an optical head (not shown in FIG. 1), and an optical head control IC 206. The main board 100 includes an analog signal microprocessor 102, a DSP/Decoder microprocessor 104, a flash ROM 106, and an SDRAM 108. The components on the main board 100 and the components on the sub-board 200 transmit signals among each other via the flexible cable 300. In addition, grounding lines 120 on the main board 100 and grounding lines 220 on the sub-board 200 are electrically connected via a connecting line 320 of the flexible cable 300. A screw 110 fastens the main board 100 to the housing, and the one of the grounding lines 120 is electrically connected to the screw 110. Thus, the housing is electrically connected to ground.

When a user slides an optical disk in or out on the tray, an electrostatic discharge current flows to the grounding lines 220 of the sub-board 200 from the user. In the prior art, the electrostatic discharge current flows from the connecting line 320 to the grounding lines 120 and is then conducted to the screw 110 so as to be released through the housing of the optical disk drive. However, before the electrostatic discharge current flows to the screw 110, the electrostatic discharge current may damage microprocessors or chips on the main board 100 so that the main board cannot function normally.

### SUMMARY OF INVENTION

It is therefore a primary objective of the claimed invention to provide an electrostatic discharge protection circuit to solve the above-mentioned problems.

According to the claimed invention, an electrostatic discharge protection circuit includes a first printed circuit board including a first grounding line, a flexible cable including a connecting line having one end connected to the first grounding line, an electrostatic discharge protection path having one end connected to the first grounding line, a second printed circuit board including a second grounding line electrically connected to another end of the connecting line, and a housing connected to another end of the electrostatic discharge protection path.

According to the claimed invention, an electrostatic discharge protection circuit includes a housing, and an electrostatic discharge protection path installed between a printed circuit board and an electric appliance for receiving an electrostatic discharge current generated by the electric appliance and conducting the electrostatic discharge current to the housing directly.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of circuit boards of a conventional slim optical disk drive.

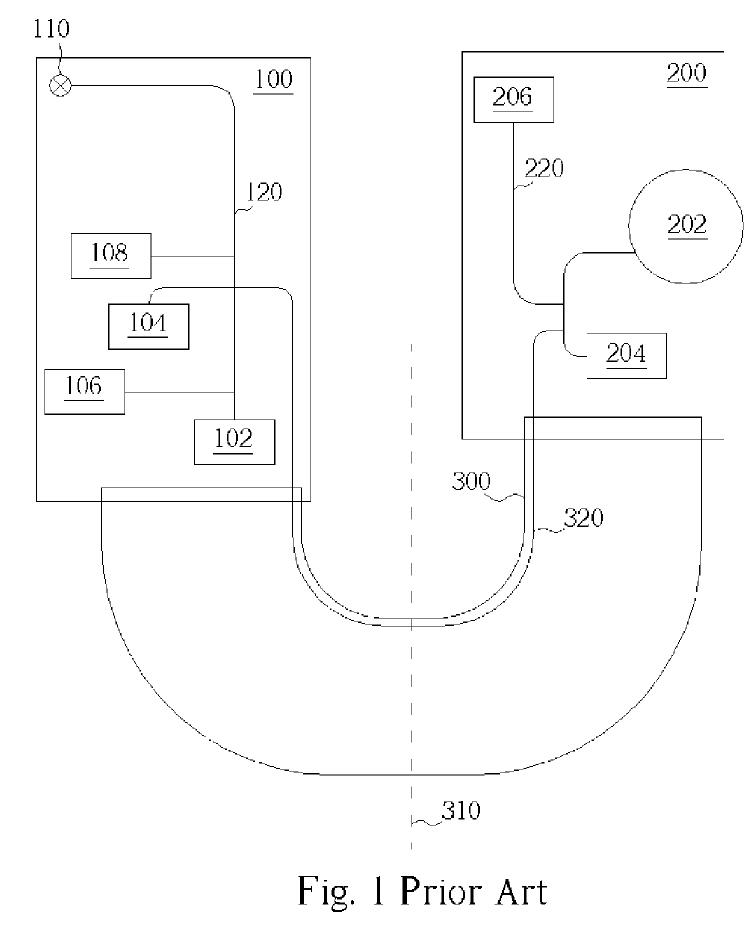

FIG. 2 is a schematic diagram of circuit boards of a slim optical disk drive according to the present invention.

### DETAILED DESCRIPTION

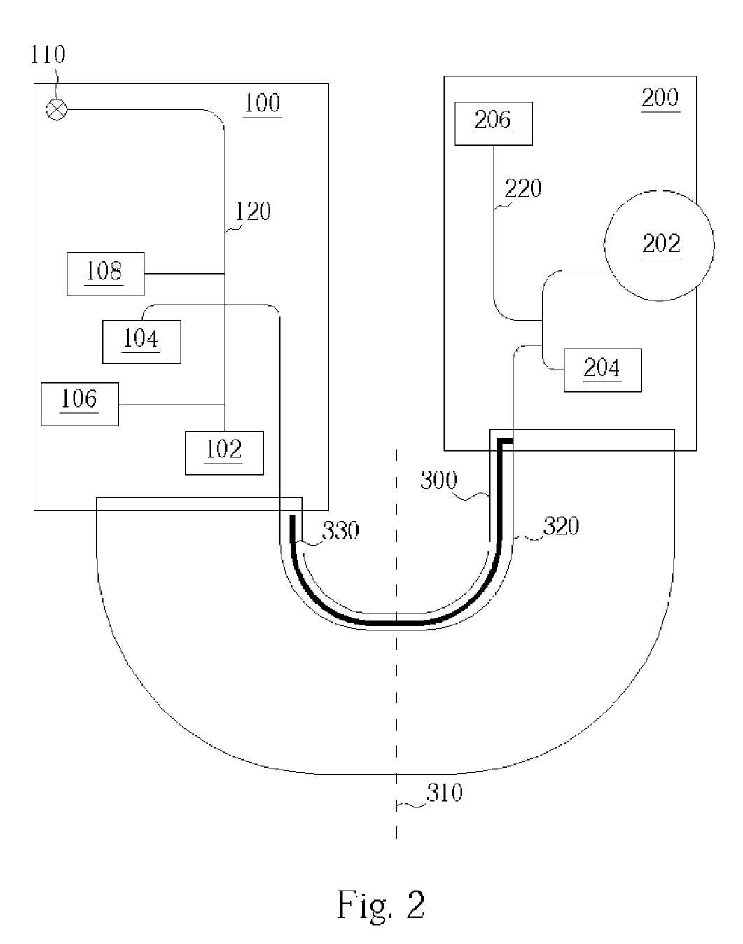

Please refer to FIG. 2. FIG. 2 is a schematic diagram of circuit boards of a slim optical disk drive according to the present invention. Please note that elements with the same reference numerals are substantially the same. An electrostatic discharge protection circuit of the slim optical disk drive according to the present invention includes a sub-board 200 fixed on a tray, a main board 100 fixed on a housing, and a flexible cable 300. The flexible cable 300, which can be a U-shaped flexible cable, can transmit control signals between the main board 100 and the sub-board 200. Although the sub-board 200 slides in and out with the tray, the sub-board 200 still can communicate with the main board 100 via the flexible cable 300.

The sub-board 200 includes a spindle motor 202, a motor driving IC 204, an optical head (not shown in FIG. 2), and an optical head control IC 206. The main board 100 includes an analog signal microprocessor 102, a DSP/Decoder microprocessor 104, a flash ROM 106, and an SDRAM 108. The components on the main board 100 and the components on the sub-board 200 transmit signals between each other via the flexible cable 300. The main board 100 further includes grounding lines 120 electrically connected to the analog signal microprocessor 102, the DSP/Decoder microprocessor 104, the flash ROM 106, and the SDRAM 108. The sub-board 200 further includes grounding lines 220 electrically connected to the spindle motor 202, the motor driving IC 204, and the optical head control IC 206. A screw 110 fastens the main board 100 to the housing, and grounding lines 120 is electrically connected to the screw 110. Thus, the housing is electrically connected to ground. The grounding lines 120 on the main board 100 are connected to the screw 110 directly.

The flexible cable 300 includes a connecting line 320 for connecting the grounding lines 120 of the main board 100 and the grounding lines 220 of the sub-board 200. The flexible cable 300 further includes an electrostatic discharge protection path 330. According to the invention, one end of the electrostatic discharge protection path 330 is electrically connected to the connecting line 320 near the sub-board 200, and the other end of the electrostatic discharge protection path 330 is not connected to the main board 100. Also, the other end of the electrostatic discharge protection path 330 of the flexible cable 300 is directly contacted to the housing without insulation (i.e. bare wire). That is, the part between a dotted line 310 and the main board 100 of the flexible cable 300 adheres to the housing directly. Because there is no insulating protection of the part of the electrostatic discharge protection path 330 contacting the housing, an electrostatic discharge current generated by the sub-board 200 can be conducted to the housing via the electrostatic discharge protection path 330 directly so that the electrostatic discharge current can be released from the housing of the optical disk drive.

In contrast to the prior art, the electrostatic discharge protection circuit according to the present invention can prevent electrostatic discharge current from passing through microprocessors or chips on the main board so as to protect electric components on the main board. The present invention can prevent damage caused by electrostatic discharge current so that the main board can function normally.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electrostatic discharge protection circuit comprising:
a first printed circuit board comprising a first grounding line;
a flexible cable comprising a connecting line having one end connected to the first grounding line, and an electrostatic discharge protection path having one end connected to the first grounding line;
a second printed circuit board comprising a second grounding line electrically connected to another end of the connecting line; and
a housing connected to another end of the electrostatic discharge protection path.

2. The electrostatic discharge protection circuit of claim 1 wherein the first printed circuit board is fixed on a tray of an optical disk drive and the second printed circuit board is fixed in the housing.

3. The electrostatic discharge protection circuit of claim 2 wherein the optical disk drive is a slim optical disk drive.

4. The electrostatic discharge protection circuit of claim 1 wherein the flexible cable is a U-shaped flexible cable.

5. The electrostatic discharge protection circuit of claim 1 wherein the other end of the electrostatic discharge protection path is connected to the housing without insulation.

6. An electrostatic discharge protection circuit located between a printed circuit board and an electric appliance, wherein the improvement comprises:
an electrostatic discharge protection path installed between the printed circuit board and the electric appliance for receiving an electrostatic discharge current generated by the electric appliance and conducting the electrostatic discharge current to a housing directly.

7. The electrostatic discharge protection circuit of claim 6 wherein the electrostatic discharge protection path is in a flexible cable connected between the electric appliance and the circuit board.

8. The electrostatic discharge protection circuit of claim 7 wherein the flexible cable is a U-shaped flexible cable.

9. The electrostatic discharge protection circuit of claim 7 wherein one end of the electrostatic discharge protection path is connected to the housing without insulation.

10. The electrostatic discharge protection circuit of claim 9 wherein another end of the electrostatic discharge protection path is electrically connected to the electric appliance.

11. The electrostatic discharge protection circuit of claim 6 wherein the electric appliance is installed on a tray of an optical disk drive and the circuit board is fixed in the housing.

12. The electrostatic discharge protection circuit of claim 11 wherein the optical disk drive is a slim optical disk drive.
